(19) United States
(12) Patent Application Publication
(10) Pub. No.: US 2016/0292877 A1
(43) Pub. Date: Oct. 6, 2016

(54) SIMD ALGORITHM FOR IMAGE DILATION AND EROSION PROCESSING

(71) Applicants: Hao YUAN, Beijing (CN); Li-An TANG, El Dorado Hills, CA (US); INTEL CORPORATION, Santa Clara, CA (US)

(72) Inventors: Hao Yuan, Beijin (CN); Li-An Tang, El Dorado Hills, CA (US)

(21) Appl. No.: 13/977,509

(22) PCT Filed: Mar. 29, 2013
(86) PCT No.: PCT/CN2013/000369

§ 371 Date: Jun. 28, 2013

(51) Int. Cl. G06T 7/00; G06T 5/30; G06T 1/20

(52) U.S. Cl. CPC G06T 7/0091; G06T 1/20; G06T 5/30; G06T 2200/28; G06T 2207/20021; G06T 2207/20036; G06T 2210/44; G06T 2210/52; G06T 2207/10116

(57) ABSTRACT

Systems and methods may receive an input image for data processing, divide the input image into a plurality of blocks, each block including a plurality of rows, and each row including a plurality of pixels and process each pixel in the input image within a row in parallel with a user-defined template. In one example, the user-defined template is to include a structuring element and a row pixel mask.

### FIELD OF THE INVENTION

Embodiments described herein generally relate to image processing, and more particularly to image processing using single instruction multiple data (SIMD) processors.

### BACKGROUND

Mathematical morphology has been applied to digital image processing as a tool for extracting image components that are useful in the representation and description of region shape, such as, for example, boundaries, skeletons, and the convex hull. Dilation and erosion are two primitive operations in morphological processing and widely used in medical image processing.

### BRIEF DESCRIPTION OF THE DRAWINGS

The various advantages of the embodiments of the present invention will become apparent to one skilled in the art by reading the following specification and appended claims, and by referencing the following drawings, in which:

FIG. 1 is a block diagram of an example of a computing system according to an embodiment;

FIG. 2 is a flowchart of an example of a method of determining a boundary data value unit and associated index according to an embodiment;

FIG. 3 is a pictorial illustration of a user-defined template operation according to an embodiment;

FIG. 4 is a block diagram of a system according to an embodiment; and

FIG. 5 is a diagram of a device according to an embodiment.

### DETAILED DESCRIPTION

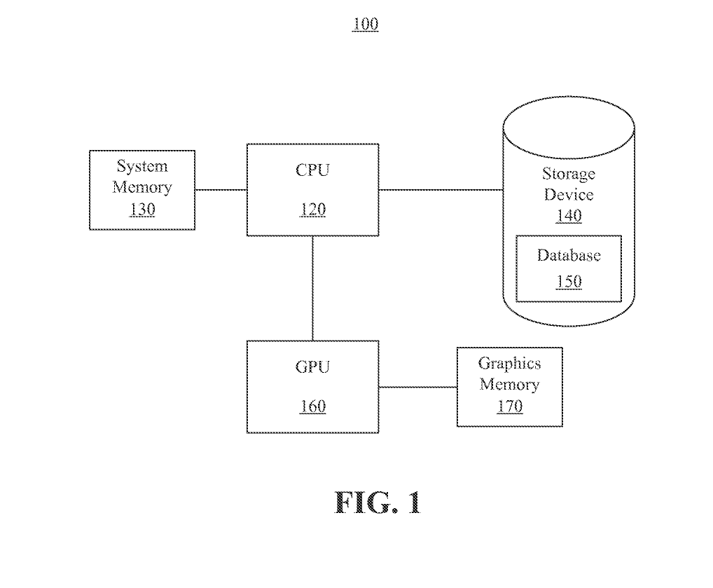

Turning now to FIG. 1, a computing system 100 is shown, including a central processing unit (CPU) 120, system memory 130, storage device 140, including database 150, a graphics processing unit (GPU) 160 and graphics memory 170. The illustrated system 100 may be part of a mobile platform such as a laptop, personal digital assistant (PDA), wireless smart phone, media player, imaging device, mobile Internet device (MID), smart tablet etc., or any combination thereof. The system 100 may also be part of a fixed platform such as a personal computer (PC), server, workstation, etc.

The CPU 120 may include a memory controller (not shown) that provides access to system memory 130, which may include random access memory, such as, for example, dual data rate (DDR) synchronous dynamic random access memory modules. The modules of the system memory 130 may be incorporated into a single inline memory module (SIMM), dual inline memory module (DIMM), small outline DIMM (SODIMM), and so on. The CPU 120 may also have one or more drivers and/or processor cores (not shown), where each core may be fully functional with instruction fetch units, instruction decoders, level one (L1) cache, execution units, and so on. The CPU may include one or more single instruction multiple data (SIMD) processor cores. The CPU 120 may also execute an operating system (OS) such as a Microsoft Windows, Linux, or Mac (Macintosh) OS.

The storage device 140 may be implemented with a variety of components or subsystems including, for example, a magnetic disk drive, an optical drive, flash memory, or other devices capable of persistently storing information. As illustrated in FIG. 1, storage device 140 may include database 150, which stores data and programs.

The illustrated system 100 also may include a graphics processing unit (GPU) 160, such as, for example, a Graphics Media Accelerator. The GPU may have a multi-core and multi-thread architecture. The GPU may be coupled to graphics memory 170. The dedicated graphics memory 170 may include GDDR (graphics DDR) or DDR SDRAM modules, or any other memory technology suitable for supporting graphics rendering. The GPU 160 and graphics memory 170 might be installed on a graphics/video card, wherein the GPU 160 may communicate with the CPU 120 via a graphics bus such as a PCI Express Graphics (PEG, e.g., Peripheral Components Interconnect/PCI Express x16 Graphics 150W-ATX Specification 1.0, PCI Special Interest Group) bus, or Accelerated Graphics Port (e.g., AGP V3.0 Interface Specification, September 2002) bus. The graphics card may be integrated onto the system motherboard, into the main CPU 120 die, configured as a discrete card on the motherboard, etc.

The illustrated GPU 160 executes a software module as part of a graphics application. The graphics application may need to process input image data. In one example, the software module may include code to receive an input image for data processing, divide the input image into a plurality of blocks, each block including a plurality of rows, and each row including a plurality of pixels and process each pixel in the input image within a row in parallel with a user-defined template.

The software module might also include code for performing a morphological operation on the processed pixels, such as, for example, dilation or erosion operations. The software module may be written in any programming language, such as, for example, an object-oriented language such as C++, and CM (C for media).

The GPU 160 may also include one or more single instruction multiple data (SIMD) processor cores to enhance and/or support graphics performance. Thus, the illustrated approach may be particularly beneficial in a graphics environment that involves a high level of data parallelism and processing complexity.

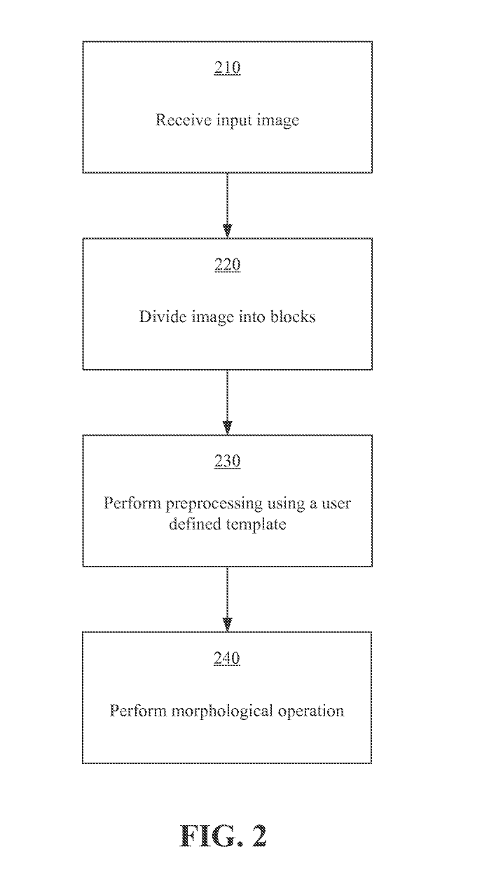

FIG. 2 shows a method of receiving an input image for data processing, dividing the input image into a plurality of blocks, each block including a plurality of rows, and each row including a plurality of pixels and processing each pixel in the input image within a row in parallel with a user-defined template

The method may be implemented in executable software as a set of logic instructions stored in a machine- or computer-readable medium of a memory such as random access memory (RAM), read only memory (ROM), programmable ROM (PROM), firmware, flash memory, etc., in configurable logic, such as, for example, programmable logic arrays (PLAs), field programmable gate arrays (FPGAs), complex programmable logic devices (CPLDs), in fixed-functionality hardware using assembly language programming and circuit technology, such as, for example, application specific integrated circuit (ASIC), complementary metal oxide semiconductor (CMOS) or transistor-transistor logic (TTL) technology, or any combination thereof.

At process block 210, the illustrated method receives an input image for data processing. The input image may be any binary image, such as, for example, an x-ray image. The input image is divided into blocks at process block 220. Each block may include a plurality of rows and each row may include a plurality of pixels. The image may be divided into blocks of a size which may be processed in a graphics processing unit thread. The graphics processing unit may include a plurality of threads for parallel processing.

Single instruction multiple data (SIMD) instructions may be utilized to perform parallel processing on a plurality of threads. For example, an input image may be divided into units to ensure that SIMD instructions (e.g., a SIMD16 instruction) may be used to process as many data units as possible in parallel to enhance the performance of the system. Any SIMD configuration may be used.

At process block 230, preprocessing is performed for each pixel in the input image (Pₛn). For each pixel (Pₛn), a matrix (Mn) having dimensions m×p (i.e. m rows and p columns) may be created for subsequent processing (e.g. morphological calculation). Each row may include neighboring pixels (Pₙₚ) to pixel (Pₛn) (i.e. origin pixel for matrix Mn). The matrix may be created based on a user-defined template. The user-defined template may include a structuring element for processing pixel (Pₛn). The template has a user defined height (m) and width (p) and may include a pixel row mask for processing each neighboring pixel (Pₙₚ) in a particular row of matrix (Mn).

The dimensions of the template may range, for example, from 2×2 to 15×15. Each row in the matrix (Mn) is processed with a different row mask that is specified by a user. The pixel row mask identifies which neighboring pixels (Pₙₚ) to include in the subsequent processing of pixel (Pₛn). Each pixel is encoded with a “1” or “0” to indicate whether the corresponding pixel is to be included in a calculation, such as, for example, a morphological mathematical calculation.

The processing of each pixel (Pₛn), may be performed, for example, as follows:

```
Dilate_5(SurfaceIndex INBUF,
    SurfaceIndex OUTBUF,
    Vector <ushort, 15>mask,
    Uint maskWidth
    )
  {
  matrix<uchar, 8, 16> srcPic = 0;
  matrix<ushort, 4, 4> dstPic = 0;
  read (INBUF, srcX − 1, srcY − 2, srcPic);
  vector< , 16> leftShift = {0, 1, 2, 3, 4, 5, 6, 7, 8, 9, 10, 11, 12, 13,
  14, 15};
  matrix<uint, 5, 16> rowMask;
      ( i = 0; i < 5; i ++)
  {
  rowMask.row(i) = ((mask(i) << (8 − maskWidth / 2)) << leftShift;
  }
  vector<uint, 16> tempPic;
  matrix<uint, 5, 16> maskPic;
  matrix<uint, 8, 16> rowPic;
  matrix<uchar, 8, 4> midPic;
```

At process block 240, the illustrated method performs a morphological operation on pixel (Pₛn) using matrix (Mn) according to the mask. Essentially, the pixels (Pₙₚ) with a mask value encoded to “1” (Pₙₚ′) are included in the calculation. The morphological operation may include an “and” operation for each row in matrix (Mn), followed by an “or” operation for the result of the “and” operation. A determination may then be made as to whether the result of the “or” operation is equal to 0. In one example, the determination (whether the result of the “or” operation is equal to 0) may be the result of a dilation operation. In another example, the determination (i.e. whether the result of the “or” operation is not equal to 0) may be the result of an erosion operation.

The morphological operation may be performed, for example, as follows:

```
midPic = srcPic.select(8, 1, 4, 1>(0, 0);
  ( i = 0; i < 8; i ++ )
{
    rowPic.row(i) = midPic.format <uint, 8, 1>( ) (i, 0);
}
  ( i = 0; i < 4; i ++)
{
  maskPic = rowPic.select<5, 1, 16, 1>(i, 0) & rowMask;
    tempPic = maskPic.row (0) | maskPic.row(1) | maskPic.row (2) |
    maskPic.row (3) | maskPic.row(4) ;
    dstPic (i, 0) = cm_pack_mask( tempPic ! = 0);
}
    write(OUTBUF, srcX, srcY, dstPic);
```

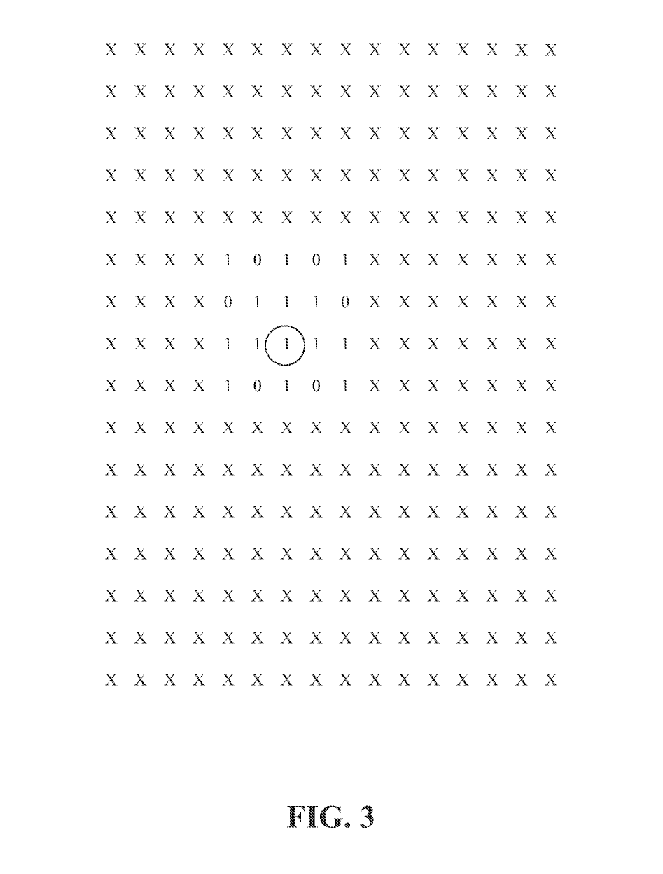

FIG. 3 illustrates an exemplary user-defined template operation. The template is 5 by 5. The circled pixel is pixel (Pₛn) for which the morphological operation/calculation is performed. The values “1” in the template indicate that the corresponding pixel should be involved in the calculation. The values “0” in the template indicate that the corresponding pixel should not be involved in the calculation. The pixel format is one (1) bit per pixel.

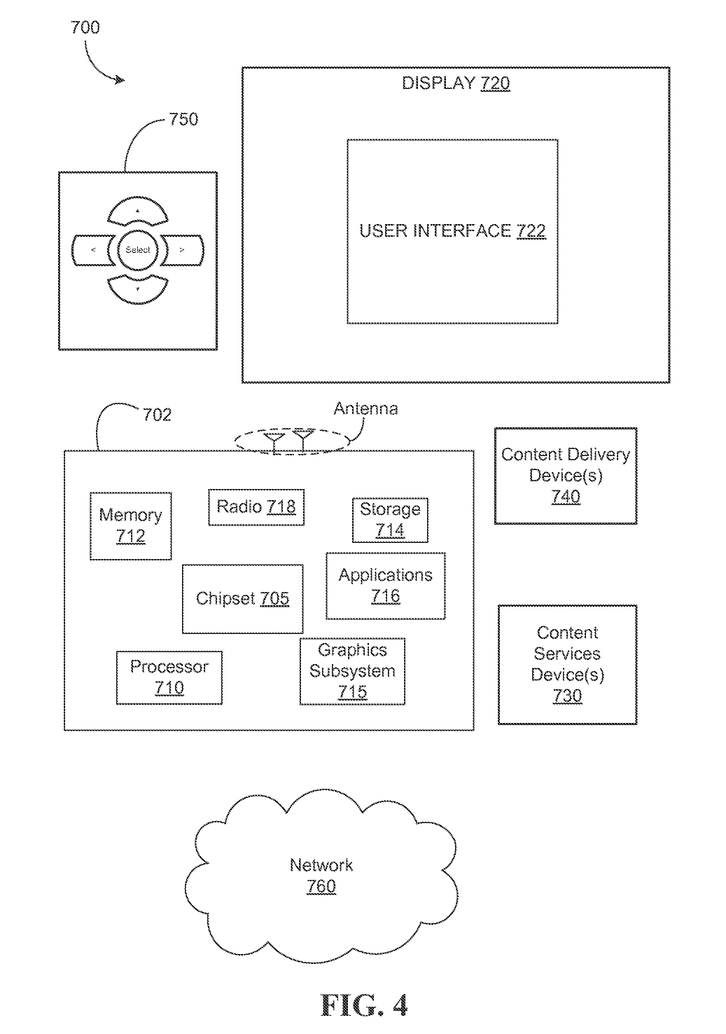

FIG. 4 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 may be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit embodiments of the invention.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to limit the invention.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 4.

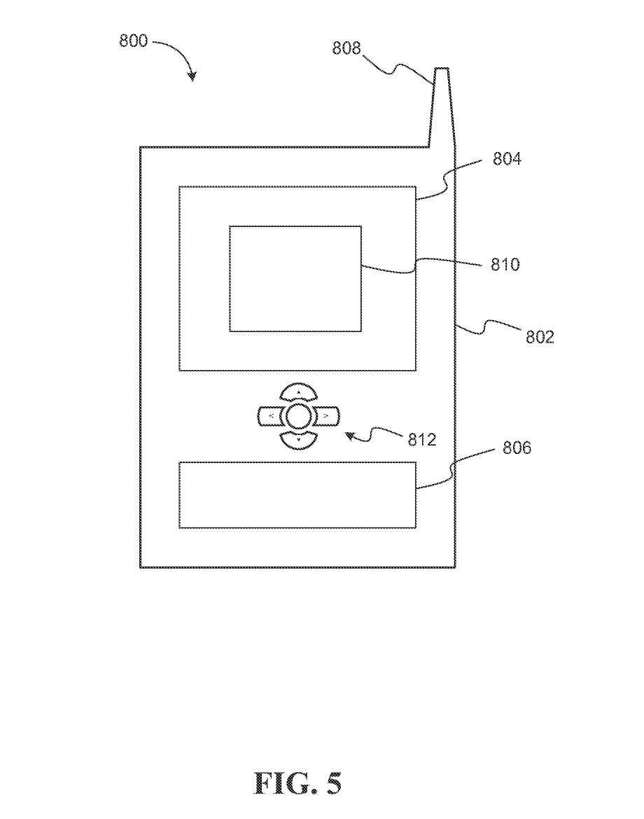

As described above, system 700 may be embodied in varying physical styles or form factors. FIG. 5 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 5, device 800 may comprise a housing 802, a display 804, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

### Additional Examples and Notes

Example 1 may also include an apparatus to process images, the apparatus including a receive module to receive an input image for data processing, a divide module to divide the input image into a plurality of blocks, each block including a plurality of rows, and each row including a plurality of pixels, and a preprocessing module to process each pixel in the input image within a row in parallel with a user-defined template.

Example 2 may include the apparatus of example 1, further comprising a module to perform a morphological operation on each preprocessed pixel using a matrix.

Example 3 may include the apparatus of example 1, wherein the user-defined template is to include a structuring element.

Example 4 may include the apparatus of example 1, wherein the user-defined template is to include a mask for processing each pixel in a particular row of a matrix.

Example 5 may include the apparatus of example 4, wherein a mask value of “1” indicates that a corresponding pixel should be used in calculating a result and a mask value of “0” indicates that a corresponding pixel should not be used in calculating a result.

Example 6 may include the apparatus of example 1, wherein the pixels in a row are processed in parallel using single instruction multiple data (SIMD) instructions.

Example 7 may include the apparatus of example 1, wherein each pixel is to include one bit per pixel.

Example 8 may include the apparatus of any one of examples 1 to 7, wherein the morphological operation is one of a dilation operation or erosion operation.

Example 9 may provide for a method of processing images, comprising receiving an input image for data processing, dividing the input image into a plurality of blocks, each block including a plurality of rows, and each row including a plurality of pixels, and preprocessing each pixel in the input image within a row in parallel with a user-defined template.

Example 10 may include the method of example 9, further comprising performing a morphological operation on each preprocessed pixel using a matrix.

Example 11 may include the method of example 9, wherein the user-defined template is to include a structuring element.

Example 12 may include the method of example 9, wherein the user-defined template is to include a mask for processing each pixel in a particular row of a matrix.

Example 13 may include the method of example 12, wherein a mask value of “1” indicates that a corresponding pixel should be used in calculating a result and a mask value of “0” indicates that a corresponding pixel should not be used in calculating a result.

Example 14 may include the method of example 9, wherein the pixels in a row are processed in parallel using single instruction multiple data (SIMD) instructions.

Example 15 may include the method of example 9, wherein each pixel is to include one bit per pixel.

Example 16 may include the method of any one of examples 9 to 15, wherein the morphological operation is one of a dilation operation or erosion operation.

Example 17 may include at least one computer readable storage medium comprising instructions, which if executed by a computing device, cause the computing device to receive an input image for data processing, divide the input image into a plurality of blocks, each block including a plurality of rows, and each row including a plurality of pixels, and preprocess each pixel in the input image within a row in parallel with a user-defined template.

Example 18 may include the at least one computer readable storage medium of example 17, further comprising instructions, which if executed by a processor, cause a computing device to perform a morphological operation on each preprocessed pixel using a matrix.

Example 19 may include the at least one computer readable storage medium of example 17, wherein the user-defined template is to include a structuring element.

Example 20 may include the at least one computer readable storage medium of any one of examples 17 to 19, wherein the user-defined template is to include a mask for processing each pixel in a particular row of a matrix.

Example 21 may include a system comprising a storage device to store an input image, a receive module to receive the input image for data processing, a divide module to divide the input image into a plurality of blocks, each block including a plurality of rows, and each row including a plurality of pixels, and a preprocessing module to process each pixel in the input image within a row in parallel with a user-defined template.

Example 22 may include the apparatus of example 21, further comprising a module to perform a morphological operation on each preprocessed pixel using a matrix.

Example 23 may include the apparatus of example 21, wherein the user-defined template is to include a structuring element.

Example 24 may include the apparatus of example 21, wherein the user-defined template is to include a mask for processing each pixel in a particular row of a matrix.

Example 25 may include the apparatus of example 24, wherein a mask value of “1” indicates that a corresponding pixel should be used in calculating a result and a mask value of “0” indicates that a corresponding pixel should not be used in calculating a result.

Example 26 may include an apparatus to process images, comprising means for performing the method of any one of examples 9 to 16.

Embodiments of the present invention are applicable for use with all types of semiconductor integrated circuit (“IC”) chips. Examples of these IC chips include but are not limited to processors, controllers, chipset components, programmable logic arrays (PLA), memory chips, network chips, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments of the present invention are not limited to the same. As manufacturing techniques (e.g., photolithography) mature over time, it is expected that devices of smaller size may be manufactured. In addition, well known power/ground connections to IC chips and other components may or may not be shown within the figures, for simplicity of illustration and discussion, and so as not to obscure certain aspects of the embodiments of the invention. Further, arrangements may be shown in block diagram form in order to avoid obscuring embodiments of the invention, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments of the invention, it should be apparent to one skilled in the art that embodiments of the invention may be practiced without, or with variation of, these specific details. The description is thus to be regarded as illustrative instead of limiting.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

Those skilled in the art will appreciate from the foregoing description that the broad techniques of the embodiments of the present invention may be implemented in a variety of forms. Therefore, while the embodiments of this invention have been described in connection with particular examples thereof, the true scope of the embodiments of the invention should not be so limited since other modifications will become apparent to the skilled practitioner upon a study of the drawings, specification, and following claims.

1-25. (canceled)

26. An apparatus to process images, comprising:
a receive module to receive an input image for data processing;
a divide module to divide the input image into a plurality of blocks, each block including a plurality of rows, and each row including a plurality of pixels; and
a preprocessing module to process each pixel in the input image within a row in parallel with a user-defined template.

27. The apparatus of claim 26, further comprising:
a module to perform a morphological operation on each preprocessed pixel using a matrix.

28. The apparatus of claim 26, wherein the user-defined template is to include a structuring element.

29. The apparatus of claim 26, wherein the user-defined template is to include a mask for processing each pixel in a particular row of a matrix.

30. The apparatus of claim 29, wherein a mask value of “1” indicates that a corresponding pixel should be used in calculating a result and a mask value of “0” indicates that a corresponding pixel should not be used in calculating a result.

31. The apparatus of claim 26, wherein the pixels in a row are processed in parallel using single instruction multiple data (SIMD) instructions.

32. The apparatus of claim 26, wherein each pixel is to include one bit per pixel.

33. The apparatus of claim 26, wherein the morphological operation is one of a dilation operation or erosion operation.

34. A method of processing images, comprising:
receiving an input image for data processing;
dividing the input image into a plurality of blocks, each block including a plurality of rows, and each row including a plurality of pixels; and
preprocessing each pixel in the input image within a row in parallel with a user-defined template.

35. The method of claim 34, further comprising:
performing a morphological operation on each preprocessed pixel using a matrix.

36. The method of claim 34, wherein the user-defined template is to include a structuring element.

37. The method of claim 34, wherein the user-defined template is to include a mask for processing each pixel in a particular row of a matrix.

38. The method of claim 37, wherein a mask value of “1” indicates that a corresponding pixel should be used in calculating a result and a mask value of “0” indicates that a corresponding pixel should not be used in calculating a result.

39. The method of claim 34, wherein the pixels in a row are processed in parallel using single instruction multiple data (SIMD) instructions.

40. The method of claim 34, wherein each pixel is to include one bit per pixel.

41. The method of claim 34, wherein the morphological operation is one of a dilation operation or erosion operation.

42. At least one computer readable storage medium comprising instructions, which if executed by a computing device, cause the computing device to:
receive an input image for data processing;
divide the input image into a plurality of blocks, each block including a plurality of rows, and each row including a plurality of pixels; and
preprocess each pixel in the input image within a row in parallel with a user-defined template.

43. The at least one computer readable storage medium of claim 42, further comprising instructions, which if executed by a processor, cause a computing device to:
perform a morphological operation on each preprocessed pixel using a matrix.

44. The at least one computer readable storage medium of claim 42, wherein the user-defined template is to include a structuring element.

45. The at least one computer readable storage medium of claim 42, wherein the user-defined template is to include a mask for processing each pixel in a particular row of a matrix.

46. A system comprising:
a storage device to store an input image;
a receive module to receive the input image for data processing;
a divide module to divide the input image into a plurality of blocks, each block including a plurality of rows, and each row including a plurality of pixels; and
a preprocessing module to process each pixel in the input image within a row in parallel with a user-defined template.

47. The apparatus of claim 46, further comprising:
a module to perform a morphological operation on each preprocessed pixel using a matrix.

48. The apparatus of claim 46, wherein the user-defined template is to include a structuring element.

49. The apparatus of claim 46, wherein the user-defined template is to include a mask for processing each pixel in a particular row of a matrix.

50. The apparatus of claim 49, wherein a mask value of “1” indicates that a corresponding pixel should be used in calculating a result and a mask value of “0” indicates that a corresponding pixel should not be used in calculating a result.

51. An apparatus to process images, comprising means for performing the method of claim 34.
